(19) United States
(12) Patent Application Publication
(10) Pub. No.: US 2023/0307603 A1
(43) Pub. Date: Sep. 28, 2023

(54) METHOD FOR PRODUCTION OF LITHIUM CARBONATE COATINGS FOR NICKEL-BASED CATHODES AND ELECTROCHEMICAL CELLS USING SAME

(71) Applicant: Solid Power Operating, Inc., Louisville, CO (US)

(72) Inventors: Collin BECKER, Boulder, CO (US); Jason E. Roberts, Denver, CO (US)

(21) Appl. No.: 18/083,225

(22) Filed: Dec. 16, 2022

Related U.S. Application Data
(60) Provisional application No. 63/265,672, filed on Dec. 17, 2021.

(51) Int. Cl. H01M 4/04; H01M 4/525; H01M 4/505; H01M 10/052; H01M 4/62

(52) U.S. Cl. CPC H01M 4/0428; H01M 4/525; H01M 4/505; H01M 10/052; H01M 4/624; H01M 2004/021

(57) ABSTRACT

A method for producing a lithium carbonate coated cathode including convertible lithium by growing lithium carbonate onto its surface by exposure to carbon dioxide. An electrochemical cell comprising a lithium carbonate coated cathode having an exterior lithium carbonate coating with thickness in the range of about 2 nanometers to about 1 micron.

### CROSS-REFERENCE TO RELATED APPLICATION

This application is related to and claims priority under 35 U.S.C. § 119 from U.S. Provisional Application No. 63/265,672, filed Dec. 17, 2021, entitled “Method for Production of Lithium Carbonate Coating for Nickel-Based Cathodes and Electrochemical Cells Using Same,” the entire contents of which is fully incorporated by reference herein for all purposes.

### TECHNICAL FIELD

Various embodiments described herein relate to the field of primary and secondary electrochemical cells, electrodes and electrode materials, including lithium carbonate coated components and corresponding methods of making and using the same.

### BACKGROUND

For lithium rechargeable batteries to meet the growing energy density requirements, researchers have turned to high energy dense oxide-based cathode materials such as the NMC class of oxides to power the batteries of today. Unfortunately, when these high energy dense materials come into direct contact with solid or liquid electrolytes, they can react and degrade leading to increased interfacial resistance, capacity fade, and diminished rate-performance during cycling. One method to prevent this degradation has been to form a coating on the cathode material to act as a buffer between the cathode and the electrolytes used. Current methods to form these coatings include techniques such as atomic layer deposition described in International Pub. No.: WO2016/196688(A8). This method, however, requires specialized equipment and high temperature operating conditions making the process complex and expensive. Described herein is a method designed to create a cost-effective coating, which not only reduces interfacial resistance, increases cycle life, and improves rate performance but also reduces the need to use multistep reactions or specialized equipment.

### SUMMARY

Provided herein are methods for producing a lithium carbonate coated cathode for an electrochemical cell comprising the steps of exposing a nickel-based cathode material comprising a 1:2 molar ratio of lithium and oxygen to gaseous carbon dioxide and water vapor; and incubating the nickel-based cathode material and the carbon dioxide for a predetermined amount of time (e.g., time period), at a predetermined temperature, at a predetermined pressure, and/or at a predetermined relative humidity level, wherein lithium carbonate is formed as a layer on an exterior surface of the cathode material to form a lithium carbonate coated cathode.

In some embodiments, the nickel-based cathode material comprises the formula LiNiₐMn_{b}Co_{c}O₂ where 0<a<1, 0<b<1, 0<c<1 and a+b+c=1. In another embodiment of the method, the nickel-based cathode material comprises NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or a combination thereof. In yet another embodiment, the nickel-based cathode material comprises one or more of a coated or uncoated metal oxide comprising LiNiO₂, LiNi_{1-Y}Co_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, Li(NiₐCo_{b}Al_{c})O₂ (0<a<1, 0<b<1, 0<c<1, a+b+c=1) or a combination thereof. In still further embodiments, the nickel-based cathode material further comprises one or more of a coated or uncoated metal oxide comprising V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (where 0≤Z≤2), LiCoPO₄, LiFePO₄, CuO, LiCo_{0.6}Mn_{0.4}O₂, LiMn_{1.5}Ni_{0.5}O₄, or a combination thereof. In still further embodiments, the nickel-based cathode material further comprises one or more of a coated or uncoated metal sulfide comprising titanium sulfide (TiS₂), molybdenum sulfide (MoS₂), iron sulfide (FeS, FeS₂), copper sulfide (CuS), nickel sulfide (Ni₃S₂) lithium sulfide (Li₂S), or combination thereof.

In some embodiments, the exposing step includes applying an elevated pressure to increase the rate of growth of the lithium carbonate coating. In some additional embodiments, the exposing step includes applying an elevated temperature to increase the rate of growth of the lithium carbonate coating.

In some embodiments, the predetermined temperature ranges from about 20 to about 120° C.

In some embodiments, the exposing step includes applying an elevated concentration of gaseous carbon dioxide for a predetermined amount of time to increase the rate of growth of the lithium carbonate coating. In some additional embodiments, the exposing step includes applying an elevated concentration of gaseous carbon dioxide for a predetermined time period to increase the rate of growth of the lithium carbonate coating.

In some embodiments, the exposing step includes applying an elevated concentration of water vapor for a predetermined amount of time to increase the rate of growth of the lithium carbonate coating. In some additional embodiments, the exposing step includes applying an elevated concentration of water vapor for a predetermined time period to increase the rate of growth of the lithium carbonate coating.

In some embodiments, the nickel-based cathode material is coated with a lithium-containing layer prior to exposing to gaseous carbon dioxide and water vapor.

In some embodiments, the lithium-containing layer comprises Li₂ZrO₃, Li₂ZrO₄, LiCl, LiF, LiOH, Li₂O, lithium niobate, lithium nitride, lithium titanate, lithium silicate or a combination thereof.

In some embodiments, the nickel-based cathode material is untreated prior to exposing to gaseous carbon dioxide and water vapor.

In some embodiments, the lithium carbonate coating has a thickness in the range from about 5 nanometers to about 1 micrometer.

In some embodiments, the method further comprises vacuum drying of the lithium carbonate coated cathode to remove residual moisture.

In some embodiments, the method further comprises washing of the lithium carbonate coated cathode.

In some embodiments, the method comprises combining the lithium carbonate coated cathode with one or more of suitable binders, solid electrolytes and conductive additives to form a cathode for an electrochemical cell.

In some embodiments, the method further comprises integrating the lithium carbonate coated cathode with an anode and separator to form a functioning electrochemical cell.

Further provided herein is an electrochemical cell comprising a lithium carbonate coated cathode having an exterior lithium carbonate coating with thickness in the range of about 2 nanometers to about 1 micron.

Further provided herein are methods for gaseously producing a uniformly coated cathode with lithium carbonate. The methods generally comprise the steps of contacting gaseous carbon dioxide and water vapor to a nickel-based cathode material comprising a lithium and oxygen; and gaseously producing a uniformly coated cathode with lithium carbonate, wherein lithium carbonate is uniformly formed as a layer on an exterior surface of the cathode material to form a lithium carbonate coated cathode.

In some embodiments, the method further comprises contacting the nickel-based cathode material and the carbon dioxide at a predetermined relative humidity level. In some additional embodiments, the method further comprises contacting the nickel-based cathode material and the carbon dioxide for a predetermined amount of time, at a predetermined temperature, at a predetermined pressure, or at a predetermined relative humidity level.

In some embodiments, the cathode material comprises a 1:2 molar ratio of lithium and oxygen.

In some embodiments, the nickel-based cathode material comprises a catalytic amount of nickel.

In some embodiments, the uniform lithium carbonate coating has a thickness in the range from about 5 nanometers to 1 micrometer. In some aspects, the uniform lithium carbonate coating has a thickness in the range from about 1 nanometer to about 100 nanometers, from about 1 nanometer to about 50 nanometers, or from about 10 nanometers to about 40 nanometers.

Further provided herein is a solid state battery cell comprising a nickel-based cathode material comprising the formula LiNiₐMn_{b}Co_{c}O₂ where 0<a<1, 0<b<1, 0<c<1 and a+b+c=1, wherein the nickel-based cathode material is uniformly coated cathode with lithium carbonate, and wherein the solid state battery cell maintains 85% or more, 90% or more, 95% or more, 98% or more, or 99% or more of its discharge capacity after it cycles three times.

Further provided herein is solid state battery cell comprising a nickel-based cathode material comprising the formula LiNiₐMn_{b}Co_{c}O₂ where 0<a<1, 0<b<1, 0<c<1 and a+b+c=1, wherein the nickel-based cathode material is uniformly coated with lithium carbonate, and wherein the solid state battery cell has a higher starting discharge capacity as compared to the same nickel-based cathode material without the lithium carbonate coating.

Further provided herein is a cathode composition comprising a cathode material comprising the formula LiNiₐMn_{b}Co_{c}O₂ where 0<a<1, 0<b<1, 0<c<1 and a+b+c=1; and a lithium carbonate layer, wherein the cathode material is uniformly coated with the lithium carbonate layer. In some embodiments, the lithium carbonate layer has a thickness from about 1 nanometer to about 1 micron.

In some embodiments, the cathode material is selected from the group consisting of LiNi_{0.33}Mn_{0.33}Co_{0.33}O₂, LiNi_{0.4}Mn_{0.3}Co_{0.3}O₂, LiNi_{0.5}Mn_{0.3}Co_{0.2}O₂, LiNi_{0.6}Mn_{0.2}Co_{0.2}O₂, LiNi_{0.8}Mn_{0.1}Co_{0.1}O₂, LiNi_{0.85}Mn_{0.05}Co_{0.1}O₂, and any combination thereof.

In some additional embodiments, the cathode material further comprises a metal oxide. In some aspects, the metal oxide is selected from the group consisting of LiNiO₂, LiNi_{1-Y}Co_{Y}O₂ (where 0≤Y<1), LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄ (where 0≤Z≤2), Li(NiₐCo_{b}Al_{c})O₂ (where 0<a<1, 0<b<1, 0<c<1, a+b+c=1), and any combination thereof. In other embodiments, the metal oxide is selected from the group consisting of V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (where 0≤Z≤2), LiCoPO₄, LiFePO₄, CuO, LiCo_{0.6}Mn_{0.4}O₂, LiMn_{1.5}Ni_{0.5}O₄, and any combination thereof.

In some embodiments, the lithium carbonate layer is gaseously formed.

Further provided herein is a cathode composition comprising a cathode material comprising LiNiO₂, LiNi_{1-Y}Co_{Y}O₂ (where 0≤Y<1), LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄ (where 0≤Z≤2), or Li(NiₐCo_{b}Al_{c})O₂ (where 0<a<1, 0<b<1, 0<c<1, a+b+c=1); and a lithium carbonate layer, wherein the cathode material is uniformly coated with the lithium carbonate layer. In some embodiments, the lithium carbonate layer has a thickness from about 1 nanometer to about 1 micron.

Further provided herein is a cathode composition comprising a cathode material comprising V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (where 0≤Z≤2), LiCoPO₄, LiFePO₄, CuO, LiCo_{0.6}Mn_{0.4}O₂, or LiMn_{1.5}Ni_{0.5}O₄; and a lithium carbonate layer, wherein the cathode material is uniformly coated with the lithium carbonate layer. In some embodiments, the lithium carbonate layer has a thickness from about 1 nanometer to about 1 micron.

Further provided herein is a method for gaseously producing a lithium carbonate coated cathode for an electrochemical cell comprising the steps of exposing a nickel-based cathode material comprising a 1:2 molar ratio of lithium and oxygen to gaseous carbon dioxide and water vapor; and incubating the nickel-based cathode material and the carbon dioxide for a predetermined amount time, at a predetermined temperature, at a predetermined pressure, and/or at a predetermined relative humidity level, wherein lithium carbonate is formed as a uniform layer on an exterior surface of the cathode material to form a lithium carbonate coated cathode.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic cross-sectional view of an example of uncoated and coated cathode material, in accordance with an embodiment.

FIG. 2 is a schematic cross-sectional view of an example of coated cathode material used in the construction of an electrochemical cell, in accordance with an embodiment.

FIG. 3 is a flow chart of a process for growing a lithium carbonate layer on a cathode material and using the resultant material in an electrochemical cell, in accordance with an embodiment.

FIGS. 4A and 4B show charts demonstrating the difference between a coated cathode material and an uncoated cathode material regarding performance in an electrochemical cell, in accordance with an embodiment. FIG. 4A shows the performance of an electrochemical cell comprising the coated cathode material of Example 1 and the uncoated cathode material of Comparative Example 1. FIG. 4B shows the performance of an electrochemical cell comprising the coated cathode material of Example 2 and the uncoated cathode material of Comparative Example 2.

FIG. 5 is an attenuated total reflectance fourier transform infrared (ATR-FTIR) spectroscopy scan displaying the presence of Li₂CO₃ on a coated NMC 622 (LiNi_{0.6}Mn_{0.2}Co_{0.2}O₂) material compared to an uncoated NMC 622 (LiNi_{0.6}Mn_{0.2}Co_{0.2}O₂) material, in accordance with an embodiment.

FIG. 6 is an ATR-FTIR spectroscopy scan displaying the presence of Li₂CO₃ on a coated NMC 851005 (LiNi_{0.85}Mn_{0.05}Co_{0.1}O₂) material compared to an uncoated NMC 851005 (LiNi_{0.85}Mn_{0.05}Co_{0.1}O₂) material, in accordance with an embodiment

FIG. 7 is an ATR-FTIR spectroscopy scan of Comparative Example 3 showing the lack of Li₂CO₃ on a NMC 622 (LiNi_{0.6}Mn_{0.2}Co_{0.2}O₂) material after exposure to a relative humidity level outside the enabling embodiments, and Examples 3-5 showing the presence of a Li₂CO₃ on a NMC 622 (LiNi_{0.6}Mn_{0.2}Co_{0.2}O₂) material after exposure to a relative humidity within the required humidity limit in accordance with an embodiment.

FIG. 8 is an ATR-FTIR spectroscopy scan of pristine uncoated NMC-622 particles (Example 6-A), NMC-622 material after exposure to a relative humidity within the required humidity limit in accordance with an embodiment (Example 6-B), pristine uncoated LMO material (Comparative Example 4-A), LMO (Comparative Example 4-B) material after exposure to a relative humidity within the required humidity limit in accordance with an embodiment, pristine uncoated LCO particles (Comparative Example 5-A), and LCO material after exposure to a relative humidity within the required humidity limit in accordance with an embodiment (Comparative Example 5-B).

FIG. 9 is an ATR-FTIR spectroscopy scan of pristine uncoated NMC-622 particles (Example 6-A), NMC-622 material after exposure to a relative humidity within the required humidity limit in accordance with an embodiment (Example 6-C), pristine uncoated NMC 851005 particles (Example 7-A), and NMC 851005 material after exposure to a relative humidity within the required humidity limit in accordance with an embodiment (Example 7-B).

### DETAILED DESCRIPTION OF ILLUSTRATED EMBODIMENTS

In the following description, specific details are provided to impart a thorough understanding of the various embodiments of the disclosure. Upon having read and understood the specification, claims and drawings hereof, however, those skilled in the art will understand that some embodiments of the disclosure may be practiced without hewing to some of the specific details set forth herein. Moreover, to avoid obscuring the disclosure, some well-known methods, processes, devices, and systems finding application in the various embodiments described herein are not disclosed in detail.

Provided herein are compositions for use in an electrochemical cell. The compositions generally comprise a cathode material and a uniform lithium carbonate layer. The uniform lithium carbonate layer fully coats the cathode material. The lithium carbonate layer acts as a barrier between the cathode material and the solid state electrolyte, thereby improving the stability of the electrochemical cell.

The cathode material may comprise a nickel-manganese-cobalt (NMC) material. The NMC material may have an average particle size from about 1 micron to about 20 microns. The NMC material may have the formula LiNiₐMn_{b}Co_{c}O₂, where 0<a<1, 0<b<1, 0<c<1 and a+b+c=1. In exemplary embodiments, the NMC material may comprise NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), NMC 851005 (LiNi_{0.85}Mn_{0.05}Co_{0.1}O₂), or any combination thereof.

In another embodiment, the cathode material may comprise a metal oxide. The metal oxide may comprise LiNiO₂, LiNi_{1-Y}Co_{Y}O₂ (where 0≤Y<1), LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄ (where 0<Z≤2), Li(NiₐCo_{b}Al_{c})O₂ (where 0<a<1, 0<b<1, 0<c<1, a+b+c=1), or any combination thereof. In another embodiment, the metal oxide may comprise V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (where 0<Z≤2), LiCoPO₄, LiFePO₄, CuO, LiCo_{0.6}Mn_{0.4}O₂, LiMn_{1.5}Ni_{0.5}O₄, or any combination thereof.

The uniform lithium carbonate layer of the composition may have a thickness from about 1 nanometer to about 1 micron; for example, the thickness of the lithium carbonate layer may be from about 1 nanometer to about 5 nanometers, about 1 nanometer to about 10 nanometers, about 1 nanometer to about 20 nanometers, about 1 nanometer to about 50 nanometers, about 1 nanometer to about 100 nanometers, about 1 nanometer to about 250 nanometers, about 1 nanometer to about 500 nanometers, about 1 nanometer to about 750 nanometers, about 1 nanometer to about 1 micron, about 5 nanometers to about 1 micron, about 10 nanometers to about 1 micron, about 20 nanometers to about 1 micron, about 50 nanometers to about 1 micron, about 100 nanometers to about 1 micron, about 250 nanometers to about 1 micron, about 500 nanometers to about 1 micron, or about 750 nanometers to about 1 micron. In some embodiments, the thickness may be from about 5 nanometers to about 750 nanometers. In another embodiment, the thickness may be from about 10 nanometers to about 500 nanometers. In a further embodiment, the thickness may be from about 15 nanometers to about 250 nanometers. In yet another embodiment, the thickness may be from about 17 nanometers to about 100 nanometers. In another embodiment, the thickness may be from about 20 nanometers to about 50 nanometers. As used herein, the term “uniform” in reference to the lithium carbonate layer is understood to encompass a lithium carbonate layer that is evenly coated, that fully covers the surface of the cathode layer (i.e., there are no patches of uncoated cathode), and/or that is coated such that the resultant composition is devoid of uncoated surface areas that might otherwise be seen with a liquid deposition or spraying technique.

Preferably, the uniform lithium carbonate coating layer is gaseously formed. The gaseously-formed lithium carbonate coating layer may be formed by contacting gaseous carbon dioxide and water vapor to a cathode material comprising lithium and oxygen, as described further below.

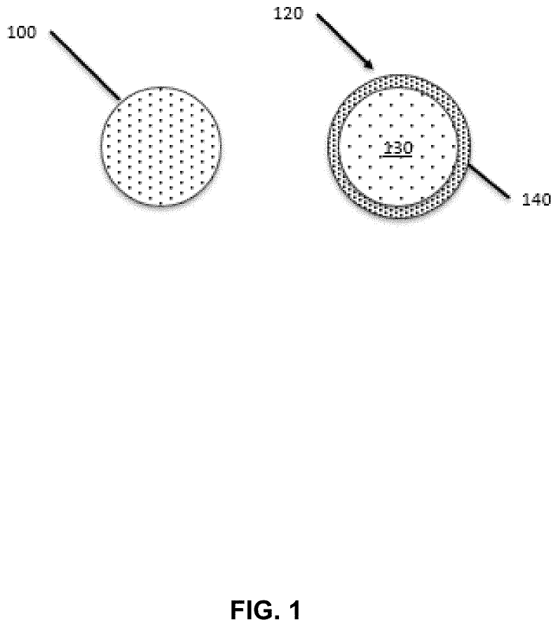

FIG. 1 is a schematic cross-sectional view of an example of uncoated and coated cathode material. Uncoated cathode material 100 may be, for example, a particle of NMC (nickel-manganese-cobalt) material ranging in size from approximately 1 to 20 microns diameter. NMC material is stoichiometrically in the form of LiNiₐMn_{b}Co_{c}O₂, where 0<a<1, 0<b<1, 0<c<1 and a+b+c=1. Commonly designated NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), NMC 851005 (LiNi_{0.85}Mn_{0.05}Co_{0.1}O₂), or any combination thereof. In an NMC material that does not contain extra lithium, the ratio of one molar fraction of lithium to two molar fractions of oxygen is fixed. Any lithium above this ratio can be referred to as “extra lithium” and any lithium within this ratio can be referred to as “convertible lithium”. Lithium included in uncoated cathode material 100 is in a chemical state, which is able to migrate and to be convertible into a lithium carbonate layer grown on the surface of coated cathode material 120 without negatively impacting the electrochemical performance or structure of the uncoated cathode material 100. Uncoated cathode material 100 must include nickel and may include lithium, manganese, oxygen, cobalt, aluminum, and other transition metals.

Coated cathode material 120 includes an inner portion 130 that has a lithium content less than the lithium content of uncoated cathode material 100 due to migration of lithium to an outer grown lithium carbonate layer 140. In one embodiment, the amount of lithium is a gradient in the coated cathode material where the outer portions have an increased amount of lithium in comparison to that of the inner portions. Although shown as idealized spherical particles, it may be understood that the uncoated cathode material 100 and coated cathode material 120 may be of a shape/size permitting the growth of the lithium carbonate and have an initial or resultant variable surface texture/roughness after the growth of the lithium carbonate. The resultant lithium carbonate layer acts as a barrier between the NMC and contacting solid state electrolyte, improving cell stability. Without a coating, the NMC cathode material would react with the solid electrolyte and result in failure of any electrochemical cell fabricated with such uncoated NMC cathode material.

In another embodiment, the coated cathode material 120 may comprise one or more of a coated or uncoated metal oxide, such as but not limited to LiNiO₂, LiNi_{1-Y}Co_{Y}O₂ (where 0≤Y<1), LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄ (where 0<Z≤2), Li(NiₐCo_{b}Al_{c})O₂ (where 0<a<1, 0<b<1, 0<c<1, a+b+c=1), or any combination thereof.

In yet another embodiment, coated cathode material 120 may further comprise one or more of a coated or uncoated metal oxide, such as but not limited to V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (0<Z≤2), LiCoPO₄, LiFePO₄, CuO, LiCo_{0.6}Mn_{0.4}O₂, LiMn_{1.5}Ni_{0.5}O₄, or any combination thereof.

In yet a further embodiment, the coated cathode material 120 may further comprise one or more of a coated or uncoated metal sulfide such as but not limited to titanium sulfide (TiS₂), molybdenum sulfide (MoS₂), iron sulfide (FeS, FeS₂), copper sulfide (CuS), nickel sulfide (Ni₃S₂) and lithium sulfide (Li₂S), or combination thereof.

Composite positive electrode active material 220 may comprise the positive electrode active material in the amount of 20% by mass to 99% by mass. In another embodiment, 30% by mass to 95% by mass. In a further embodiment, 40% by mass to 92.5% by mass. In yet another embodiment, 50% by mass to 90% by mass. In another embodiment, 60% by mass to 87.5% by mass. In a further embodiment, 65% by mass to 85% by mass.

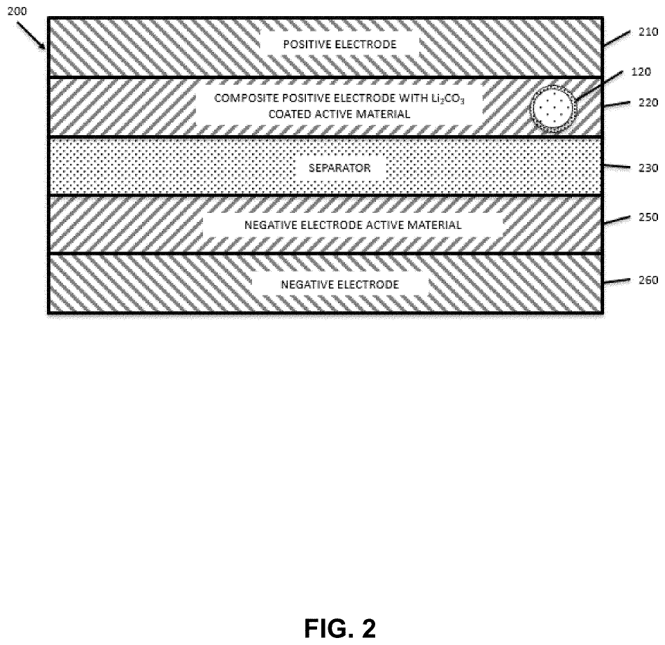

FIG. 2 is a schematic cross-sectional view of an example of coated cathode material 120 used in the construction of an electrochemical cell. Solid-state electrochemical cell 200 includes positive electrode (current collector) 210, positive electrode active material (cathode) 220, separator (solid electrolyte layer) 230, negative electrode active material (anode) 250, and negative electrode (current collector) 260. Positive electrode active material 220 may be positioned between positive electrode 210 and separator 230. Negative electrode active material 250 may be positioned between negative electrode 260 and separator 230. Positive electrode 210 electrically contacts composite positive electrode active material 220, and negative electrode 260 electrically contacts negative electrode active material 250.

Positive electrode 210 may be formed from materials including, but not limited to, Aluminum (Al), Nickel (Ni), Titanium (Ti), Stainless Steel, Magnesium (Mg), Iron (Fe), Zinc (Zn), Indium (In), Germanium (Ge), Silver (Ag), Platinum (Pt), Gold (Au), Lithium (Li), or alloy thereof. In some embodiments, the positive electrode layer 210 may be formed from one or more carbon containing material such as carbon fiber, graphite, graphene, carbon black, conductive carbon, amorphous carbon, VGCF, and carbon nanotubes. Similarly, negative electrode 260 may be formed from materials including, but not limited to, Aluminum (Al), Nickel (Ni), Titanium (Ti), Stainless Steel, Magnesium (Mg), Iron (Fe), Zinc (Zn), Indium (In), Germanium (Ge), Silver (Ag), Platinum (Pt), Gold (Au), Lithium (Li), or alloy thereof. In some embodiments, the negative electrode layer 260 may be formed from one or more carbon containing material such as carbon fiber, graphite, graphene, carbon black, conductive carbon, amorphous carbon, VGCF, and carbon nanotubes.

Composite positive electrode active material 220 may include, but is not limited to, coated cathode material 120, such as lithium carbonate coated NMC (nickel-manganese-cobalt) material, as described herein, which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof.

Composite positive electrode active material 220 may further include one or more polymers or binders such as but not limited to a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the polymer or binder may be one or more of a thermoplastic elastomer, such as but not limited, to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the polymer or binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the polymer or binder may be one or more of a polycondensation polymer such as but not limited to polyurea, polyamide paper, polyimide, polyester, and the like. In yet a further embodiment, the polymer or binder may be one or more of a nitrile rubber may be used such as but not limited to acrylonitrile-butadiene rubber (ABR), polystyrene nitrile-butadiene rubber (PS-NBR), and mixtures thereof. One or more of the binders or polymers may be added in the in the amount of 1% mass to 80% by mass. In another embodiment, 3% by mass to 70% by mass. In a further embodiment, 5% by mass to 60% by mass. In yet another embodiment, 8% by mass to 50% by mass. In another embodiment, 11% by mass to 40% by mass. In a further embodiment, 14% by mass to 30% by mass.

Composite positive electrode active material 220 may further include one or more solid electrolyte materials such as one or more of a Li₂S—P₂S₅, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In another embodiment, one or more of the solid electrolyte materials may be Li₃PS₄, Li₄P₂S₆, Li₇P₃S₁₁, Li₁₀GeP₂S₁₂, Li₁₀SnP₂S₁₂. In a further embodiment, one or more of the solid electrolyte materials may be Li₆PS₅Cl, Li₆PS₅Br, Li₆PS₅I or expressed by the formula Li_{7-y} PS_{6-y}X_{y} where “X” represents at least one halogen elements and or pseudo-halogen and where 0<y≤2.0 and where a halogen may be one or more of F, Cl, Br, I, and a pseudo-halogen may be one or N, NH, NH₂, NO, NO₂, BF₄, BH₄, AlH₄, CN, and SCN. In yet another embodiment, one or more of the solid electrolyte materials may be expressed by the formula Li_{8-y-z}P₂S_{9-y-z}X_{y}W_{z} (where “X” and “W” represent at least one halogen element and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. The solid electrolyte compositions may be added in the amount of 5% by mass to 80% by mass. In another embodiment, 7.5% by mass to 70% by mass. In a further embodiment, 10% by mass to 60% by mass. In yet another embodiment, 12.5% by mass to 50% by mass. In another embodiment, 15% by mass to 40% by mass. In a further embodiment, 17.5% by mass to 30% by mass.

Composite positive electrode active material 220 may further include one or more carbon containing species which has an electronic conductivity greater than or equal to 1 mS/cm². The carbon containing species may consist of but are not limited to carbon black, graphite, graphene, carbon nanotubes, carbon fiber, VGCF, carbon black, or amorphous carbon. In another embodiment, the composite positive electrode active material 220 may further include one or more metal particles, filaments, or other structures. The carbon containing species may be added in the amount from about 2% by mass to about 50% by mass. In another embodiment, the carbon containing species may be added in the amount from about 4% to about 40%. In a further embodiment, the carbon containing species may be added in the amount from about 6% to about 30%. In yet another embodiment, the carbon containing species may be added in the amount from about 8% to about 25%. In another embodiment, the carbon containing species may be added in the amount from about 10% to about 20%. In a further embodiment, the carbon containing species may be added in the amount from about 12% to about 18%.

The layer thickness of composite positive electrode active material 220 may be in the range of, for example, 1 μm to 1000 μm. In another embodiment, the thickness may be in the range of 2 μm to 900 μm. In yet another embodiment, the thickness may be in the range of 5 μm to 750 μm. In a further embodiment, the thickness may be in the range of 10 μm to 500 μm. In yet a further embodiment, the thickness may be in the range of 15 μm to 350 μm. In another embodiment, the thickness may be in the range of 20 μm to 200 μm. In a further embodiment, the thickness may be in the range of 25 μm to 100 μm.

Negative electrode active material 250 may include but is not limited to, alkali metal such as Lithium metal, Lithium alloys, Sodium metal, Sodium alloys, Potassium metal and Potassium alloys. In other embodiment, the negative electrode active material 250 may include one or more of an alkaline earth metal such as Magnesium metal, Magnesium alloys, Calcium metal, Calcium alloys. In a further embodiment, the negative electrode active material 250 may include one or more of a carbon containing species which has an electronic conductivity greater than or equal to 1 mS/cm where the carbon containing species may consist of but not limited to graphitic carbon, hard carbon, amorphous carbon, carbon black, vapor grown carbon fiber (VGCF), carbon nanotube, graphene or a combination thereof. In yet another embodiment, the negative electrode active material 250 may include one or more species that contain Silicon (Si), Tin (Sn), Iron (Fe), Germanium (Ge) or Indium (In), Zinc (Zn).

The thickness of negative electrode active material 250 may be in the range of, for example, 0.1 μm to 1000 μm.

Solid electrolyte material included within separator 230 is preferably one or more of a lithium sulfide based solid electrolyte such as but not limited to Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In another embodiment, one or more of the solid electrolyte materials may be Li₃PS₄, Li₄P₂S₆, Li₇P₃S₁₁, Li₁₀GeP₂S₁₂, Li₁₀SnP₂S₁₂. In a further embodiment, one or more of the solid electrolyte materials may be Li₆PS₅Cl, Li₆PS₅Br, Li₆PS₅I or expressed by the formula Li_{7-y}PS_{6-y}X_{y} where “X” represents at least one halogen elements and or pseudo-halogen and where 0<y≤2.0 and where a halogen may be one or more of F, Cl, Br, I, and a pseudo-halogen may be one or N, NH, NH₂, NO, NO₂, BF₄, BH₄, AlH₄, CN, and SCN. In yet another embodiment, one or more of the solid electrolyte materials may be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. The solid electrolyte compositions may be added in the amount of 5% by mass to 80% by mass. In another embodiment, 7.5% by mass to 70% by mass. In a further embodiment, 10% by mass to 60% by mass. In yet another embodiment, 12.5% by mass to 50% by mass. In another embodiment, 15% by mass to 40% by mass. In a further embodiment, 17.5% by mass to 30% by mass.

Separator 230 may additionally or alternatively include one or more binder or polymer such as but not limited to a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the polymer or binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the polymer or binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the polymer or binder may be one or more of a polycondensation polymer such as but not limited to polyurea, polyamide paper, polyimide, polyester, and the like. In yet a further embodiment, the polymer or binder may be one or more of a nitrile rubber may be used such as but not limited to acrylonitrile-butadiene rubber (ABR), polystyrene nitrile-butadiene rubber (PS-NBR), and mixtures thereof. One or more of the binders or polymers may be added in the in the amount of 1% mass to 80% by mass. In another embodiment, 3% by mass to 70% by mass. In a further embodiment, 5% by mass to 60% by mass. In yet another embodiment, 8% by mass to 50% by mass. In another embodiment, 11% by mass to 40% by mass. In a further embodiment, 14% by mass to 30% by mass. Separator 230 may additionally or alternatively include one or more of elemental sulfur, sodium sulfides, magnesium sulfides, and non-reactive oxides such as ZrO₂, and Al₂O₃.

The thickness of the separator layer 230 is preferably in the range of 500 nm to 1000 μm. In another embodiment, the thickness may be in the range of 1 μm to 750 μm. In yet another embodiment, the thickness may be in the range of 5 μm to 500 μm. In a further embodiment, the thickness may be in the range of 6 μm to 250 μm. In yet a further embodiment, the thickness may be in the range of 7 μm to 100 μm. In another embodiment, the thickness may be in the range of 8 μm to 50 μm. In a further embodiment, the thickness may be in the range of 10 μm to 30 μm.

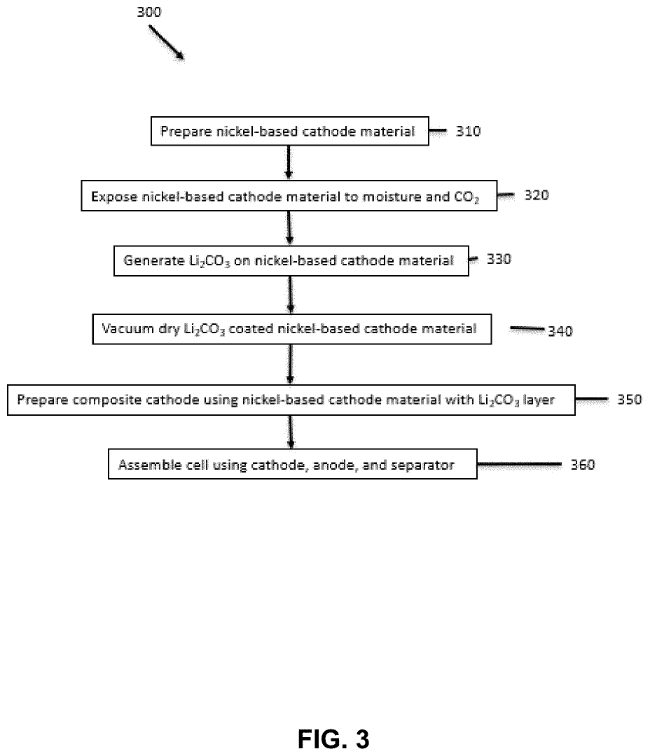

FIG. 3 is a flow chart of a process for growing a lithium carbonate layer on an uncoated cathode material and using the resultant coated material in an electrochemical cell. Process 300 begins with step 310 wherein uncoated NMC cathode material is prepared for further processing. In one embodiment, no extra lithium is incorporated into the NMC cathode material nor is the material initially coated with a lithium containing compound. Preparation may include processes such as milling and sieving to remove agglomerates. It should be noted that no special surface treatment, such as cleaning or rinsing, of the NMC cathode material may be required.

Next, during step 320, the uncoated NMC cathode material is exposed to humidity and carbon dioxide in an atmospherically controlled enclosure, room, or environment. The uncoated NMC cathode material may be exposed at ambient (room temperature typically, 20° C.) or elevated temperatures up to 120° C. for a predetermined period of time ranging from minutes to multiple days to permit the lithium within the uncoated NMC cathode material to diffuse near the surface of the material particles where the lithium reacts with the water in the humid atmosphere to produce LiOH. This LiOH may further interact with the water in the humid atmosphere and convert into a hydrate such as Lithium Hydroxide Hydrate. The LiOH and Lithium Hydroxide Hydrate may be converted into the grown lithium carbonate layer coating the material particles during step 330. Ambient pressures may also be used but increased pressure may be used to accelerate the growth of the lithium carbonate coating. Under ambient conditions (STP), cathode material may be exposed for up to 30 days to advance the growth of the lithium carbonate layer. Growing of the lithium carbonate layer in this way results in fewer coating irregularities such as agglomeration than occur with traditional coating processes such as SolGel.

Generally, higher concentrations of CO₂, higher pressures, increased temperature, and/or increased humidity, will increase the growth rate of the lithium carbonate layer. In some embodiments the pressure may be 0.1 ATM to 73 ATM. In another embodiment, the pressure may be 0.5 Atm to 50 ATM. In yet another embodiment, the pressure may be 0.75 ATM to 25 ATM. In a further embodiment, the pressure may be 1 ATM to 10 ATM. The concentration of CO₂ may be between 0.03% to 99.5% of the atmosphere. Growth conditions and rate of growth of the lithium carbonate film may also effect changes to the density and porosity of the lithium carbonate layer and the performance of any cathode fabricated from such coated material. The humidity of the environment, relative humidity (RH), may also be controlled in the range of just above zero percent to 100% or just below saturation conditions of the water vapor in the environment. In some embodiments, the relative humidity level may be from about 0% to about 5%, about 0% to about 10%, about 0% to about 20%, about 0% to about 30%, about 0% to about 40%, about 0% to about 50%, about 0% to about 60%, about 0% to about 70%, about 0% to about 80%, about 0% to about 90%, about 0% to about 95%, about 0% to about 100%, about 5% to about 100%, about 10% to about 100%, about 20% to about 100%, about 30% to about 100%, about 40% to about 100%, about 50% to about 100%, about 60% to about 100%, about 70% to about 100%, about 80% to about 100%, or about 90% to about 100%, or about 95% to about 100%. Preferably, the relative humidity level is from about 5% to about 100%, about 10% to about 100%, about 30% to about 100%, or about 40% to about 100%.

The thickness of the resultant lithium carbonate layer may be within the range of 1 nanometers to approximately 1 micron; for example, the thickness of the resultant lithium carbonate layer may be from about 1 nanometer to about 5 nanometers, about 1 nanometer to about 10 nanometers, about 1 nanometer to about 20 nanometers, about 1 nanometer to about 50 nanometers, about 1 nanometer to about 100 nanometers, about 1 nanometer to about 250 nanometers, about 1 nanometer to about 500 nanometers, about 1 nanometer to about 750 nanometers, about 1 nanometer to about 1 micron, about 5 nanometers to about 1 micron, about 10 nanometers to about 1 micron, about 20 nanometers to about 1 micron, about 50 nanometers to about 1 micron, about 100 nanometers to about 1 micron, about 250 nanometers to about 1 micron, about 500 nanometers to about 1 micron, or about 750 nanometers to about 1 micron. In some embodiments, the thickness may be from about 5 nanometers to about 750 nanometers. In another embodiment, the thickness may be from about 10 nanometers to about 500 nanometers. In a further embodiment, the thickness may be from about 15 nanometers to about 250 nanometers. In yet another embodiment, the thickness may be from about 17 nanometers to about 100 nanometers. In another embodiment, the thickness may be from about 20 nanometers to about 50 nanometers.

As the thickness of the lithium carbonate layer increases, the overall lithium contained in the cathode material decreases. The formation lithium carbonate may deplete the lithium contained in the cathode material by 0.1% and 3%. In some embodiments, the formation lithium carbonate may deplete the lithium contained in the cathode material by 0.2% and 2.5%. In another embodiment, the formation lithium carbonate may deplete the lithium contained in the cathode material by 0.25% and 1.5%. In a further embodiment, the formation lithium carbonate may deplete the lithium contained in the cathode material by 0.3% and 0.5%. Additionally, as the lithium carbonate layer grows, the porosity of the layer may have a range in the order of 1% to 50%. In some embodiments, the porosity may have a range of 3% to 40%. In another embodiment, the porosity may have a range of 5% to 30%. The nickel-based NMC cathode material may also include a lithium containing and lithium ion supporting coating layer after the growth of the lithium carbonate layer. The lithium containing layer may include Li₂ZrO₃, Li₂ZrO₄, LiCl, LiF, LiOH, Li₂O, lithium niobate, lithium nitride, lithium titanate, and lithium silicate.

Subsequent to exposure and growth of the lithium carbonate layer, during step 340, the nickel-based cathode material may be vacuum dried at ambient or elevated (up to 500° C.) temperature to remove residual moisture. Vacuum drying may not be required when the lithium carbonate growth step is performed at elevated temperatures. Optional washing processes may also be included prior to or subsequent to vacuum drying. Next, in step 350, the coated NMC cathode material may be combined with suitable binders, solid electrolytes and conductive additives to form a cathode for an electrochemical cell. Next, in step 360, the cathode may be integrated with an anode and separator to form a functioning electrochemical cell.

In some exemplary embodiments, a catalytic amount of Nickel may be used in the NMC cathode material. As used herein, a “catalytic amount of Nickel” refers to an amount of Nickel that increases the rate of a lithium carbonate formation without itself undergoing a permanent chemical change.

Further provided herein are methods for gaseously producing a uniformly coated cathode with lithium carbonate. As used herein, gaseous production of the lithium carbonate coating refers to methods of producing the lithium carbonate via a chemical reaction wherein at least one reactant is in the gas phase. The method generally comprises contacting gaseous carbon dioxide and water vapor to a nickel-based cathode material comprising lithium and oxygen, and gaseously producing a uniformly coated cathode with lithium carbonate. The lithium carbonate may be uniformly formed as a layer on an exterior surface of the cathode material to form a lithium carbonate coated cathode.

The uniform lithium carbonate layer of the composition may have a thickness from about 1 nanometer to about 1 micron; for example, the thickness of the lithium carbonate layer may be from about 1 nanometer to about 5 nanometers, about 1 nanometer to about 10 nanometers, about 1 nanometer to about 20 nanometers, about 1 nanometer to about 50 nanometers, about 1 nanometer to about 100 nanometers, about 1 nanometer to about 250 nanometers, about 1 nanometer to about 500 nanometers, about 1 nanometer to about 750 nanometers, about 1 nanometer to about 1 micron, about 5 nanometers to about 1 micron, about 10 nanometers to about 1 micron, about 20 nanometers to about 1 micron, about 50 nanometers to about 1 micron, about 100 nanometers to about 1 micron, about 250 nanometers to about 1 micron, about 500 nanometers to about 1 micron, or about 750 nanometers to about 1 micron. In some embodiments, the thickness may be from about 5 nanometers to about 750 nanometers. In another embodiment, the thickness may be from about 10 nanometers to about 500 nanometers. In a further embodiment, the thickness may be from about 15 nanometers to about 250 nanometers. In yet another embodiment, the thickness may be from about 17 nanometers to about 100 nanometers. In another embodiment, the thickness may be from about 20 nanometers to about 50 nanometers. In another embodiment, the thickness may be from about 10 nanometers to about 40 nanometers.

The method may further comprise contacting the nickel-based cathode material and the carbon dioxide for a predetermined amount of time, at a predetermined temperature, at a predetermined pressure, and/or at a predetermined relative humidity level.

The method may further comprise contacting the nickel-based cathode material and the carbon dioxide for a predetermined amount of time. The predetermined amount of time may range from minutes to days. For example, the predetermined amount of time may be about 5 minutes, about 15 minutes, about 30 minutes, about 1 hour, about 2 hours, about 4 hours, about 8 hours, about 16 hours, about 24 hours, about 48 hours, about 3 days, about 5 days, about 7 days, about 10 days, about 14 days, about 20 days, about 30 days, or more. In some embodiments, the predetermined amount of time may be from about 5 minutes to about 1 hour, about 5 minutes to about 8 hours, about 5 minutes to about 24 hours, about 5 minutes to about 48 hours, about 5 minutes to about 5 days, about 5 minutes to about 7 days, about 5 minutes to about 14 days, about 5 minutes to about 20 days, about 5 minutes to about 30 days, about 1 hour to about 30 days, about 8 hours to about 30 days, about 24 hours to about 30 days, about 48 hours to about 30 days, about 5 days to about 30 days, about 7 days to about 30 days, about 14 days to about 30 days, about 20 days to about 30 days, about 8 hours to about 24 hours, about 24 hours to about 10 days, or about 5 days to about 20 days.

The method may further comprise contacting the nickel-based cathode material and the carbon dioxide at a predetermined temperature. In some embodiments, the predetermined pressure may be from about 20° C. to about 120° C.; for example, the predetermined temperature may be from about 20° C. to about 40° C., about 20° C. to about 60° C., about 20° C. to about 80° C., about 20° C. to about 100° C., about 20° C. to about 120° C., about 40° C. to about 120° C., about 60° C. to about 120° C., about 80° C. to about 120° C., or about 100° C. to about 120° C.

The method may further comprise contacting the nickel-based cathode material and the carbon dioxide at a predetermined pressure. In some embodiments, the predetermined pressure may be from about 0.1 ATM to about 73 ATM; for example, the pressure may be from about 0.1 ATM to about 1 ATM, about 0.1 ATM to about 5 ATM, about 0.1 ATM to about 10 ATM, about 0.1 ATM to about 25 ATM, about 0.1 ATM to about 50 ATM, about 0.1 ATM to about 73 ATM, about 1 ATM to about 73 ATM, about 5 ATM to about 73 ATM, about 10 ATM to about 73 ATM, about 25 ATM to about 73 ATM, or about 50 ATM to about 73 ATM. In another embodiment, the pressure may be 0.5 Atm to 50 ATM. In yet another embodiment, the pressure may be 0.75 ATM to 25 ATM. In a further embodiment, the pressure may be 1 ATM to 10 ATM.

The method may further comprise contacting the nickel-based cathode material and the carbon dioxide at a predetermined relative humidity level. The predetermined relative humidity level may be from about 0% to about 100% or just below saturation conditions of the water vapor in the environment. For example, the predetermined relative humidity level may be from about 0% to about 5%, about 0% to about 10%, about 0% to about 20%, about 0% to about 30%, about 0% to about 40%, about 0% to about 50%, about 0% to about 60%, about 0% to about 70%, about 0% to about 80%, about 0% to about 90%, about 0% to about 95%, about 0% to about 100%, about 5% to about 100%, about 10% to about 100%, about 20% to about 100%, about 30% to about 100%, about 40% to about 100%, about 50% to about 100%, about 60% to about 100%, about 70% to about 100%, about 80% to about 100%, or about 90% to about 100%, or about 95% to about 100%.

The cathode material may comprise a 1:2 molar ratio of lithium and oxygen. The cathode material may comprise a catalytic amount of nickel.

Further provided herein is a solid state battery cell comprising the coated cathode materials described herein. The solid state battery cell may comprise any of the compositions made by the methods described herein. The battery cell may comprise a cathode material comprising a nickel-manganese-cobalt (NMC) material. The NMC material may have an average particle size from about 1 micron to about 20 microns. The NMC material may have the formula LiNiₐMn_{b}Co_{c}O₂, where 0<a<1, 0<b<1, 0<c<1 and a+b+c=1. In exemplary embodiments, the NMC material may comprise NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), NMC 851005 (LiNi_{0.85}Mn_{0.05}Co_{0.1}O₂), or any combination thereof.

In another embodiment, the cathode material may comprise a metal oxide. The metal oxide may comprise LiNiO₂, LiNi_{1-Y}Co_{Y}O₂ (where 0≤Y<1), LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄, Li(NiₐCo_{b}Al_{c})O₂ (where 0<a<1, 0<b<1, 0<c<1, a+b+c=1), or any combination thereof. In another embodiment, the metal oxide may comprise V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (0≤Z≤2), LiCoPO₄, LiFePO₄, CuO, LiCo_{0.6}Mn_{0.4}O₂, LiMn_{1.5}Ni_{0.5}O₄, or any combination thereof.

The solid state battery cell may maintain 85% or more, 90% or more, 95% or more, 98% or more, or 99% or more of its discharge capacity after it cycles three times.

The solid-state battery cell may have a higher starting discharge capacity than that of a solid-state battery cell comprising the same cathode material but without the coating. The solid-state battery cell may maintain about 85% or more of its original discharge capacity after the battery cell is cycled three times; for example, the battery cell may maintain about 90% or more, about 95% or more, about 98% or more, or about 99% or more of its original discharge capacity after the battery cell cycles three times.

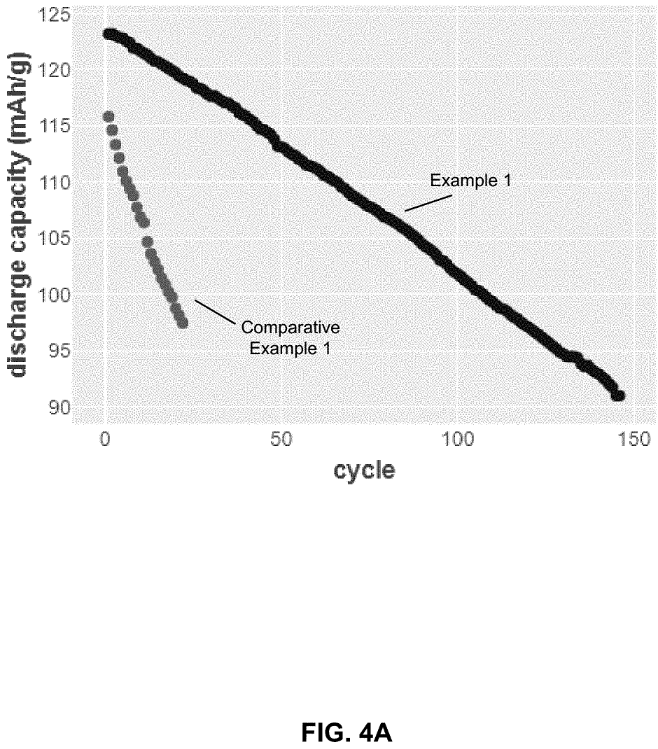

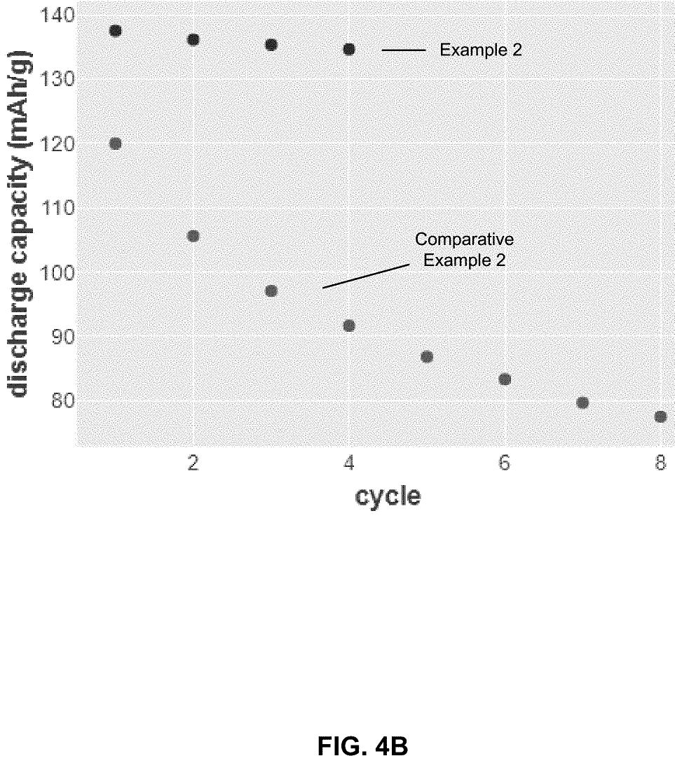

FIG. 4A is a graph of cycle numbers versus discharge capacity for a solid-state lithium metal full cell using uncoated NMC 622 in accordance with Comparative Example 1 and the same NMC 622 material with a Li₂CO₃-rich surface in accordance with Example 1. Both cells are cycled under a 0.1 C charge and 0.1 C discharge between 4.3V and 2.5V. FIG. 4B is a graph of cycle numbers versus discharge capacity for a solid-state lithium metal full cell using uncoated NMC 851005 in accordance with Comparative Example 2 and the same NMC 851005 material with a Li₂CO₃-rich surface in accordance with Example 2. Both cells are cycled under a 0.1 C charge and 0.1 C discharge between 4.3V and 2.5V.

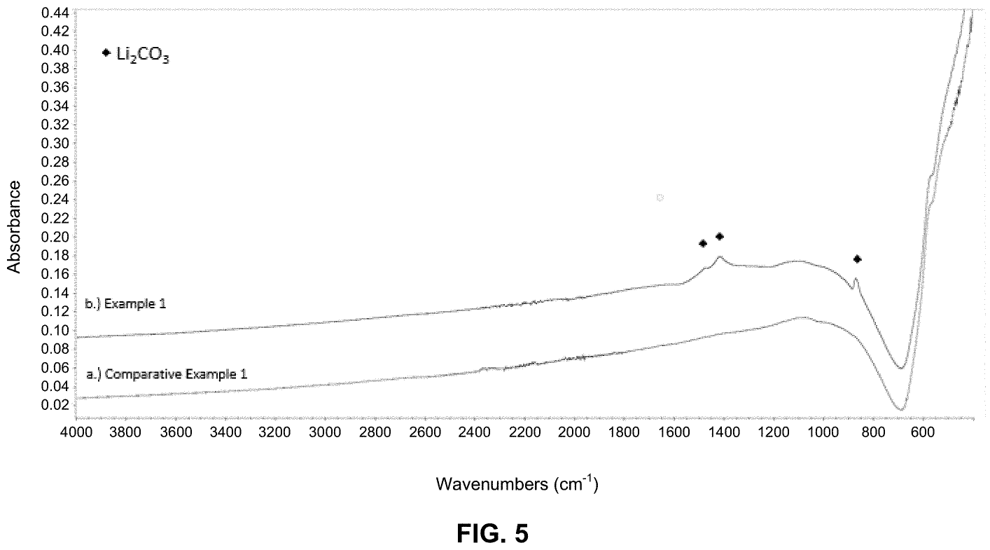

FIG. 5 is a plot of ATR-FTIR spectroscopy measurements of an NMC 622 material. Plot “Comparative Example 1” is of uncoated NMC 622 material and plot “Example 1” is of the same NMC 622 material after being coated with Li₂CO₃ in accordance with what is described in Example 1. The ATR-FTIR spectroscopy for Example 1 displays strong C—O stretching bands at v=1475 cm−1 and 1417 cm−1 and a medium intensity carbonate bending mode at v=865 cm−1 indicative of Li₂CO₃ while plot “Comparative Example 1” is devoid of such features.

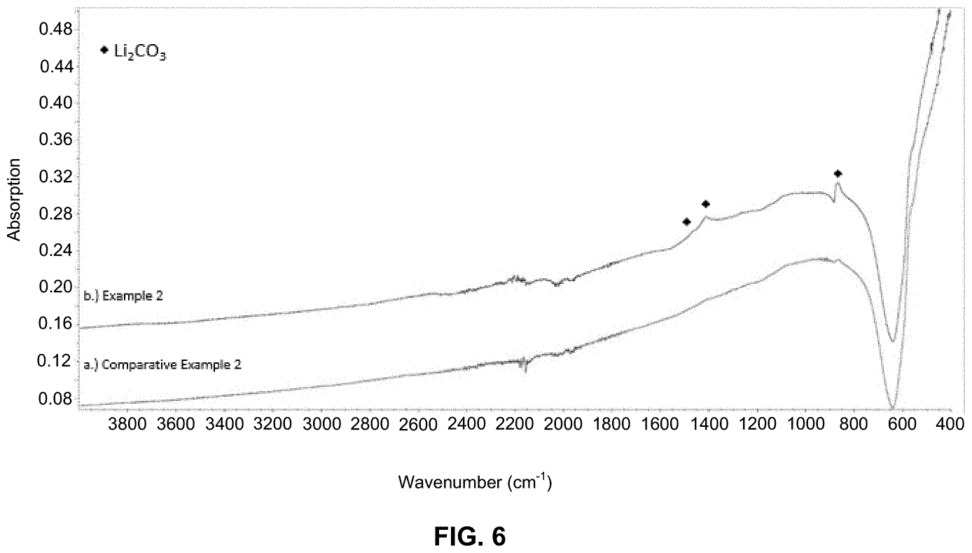

FIG. 6 is a plot of ATR-FTIR spectroscopy measurements of an NMC 851005 material. Plot “Comparative Example 2” is of uncoated NMC 851005 material and plot “Example 2” is of the same NMC 851005 material after being coated with Li₂CO₃ in accordance with Example 2. Plot “Example 2” displays strong C—O stretching bands at v=1475 cm−1 and 1417 cm−1 and a medium intensity carbonate bending mode at v=865 cm−1 indicative of Li₂CO₃ while plot “a” is devoid of such features.

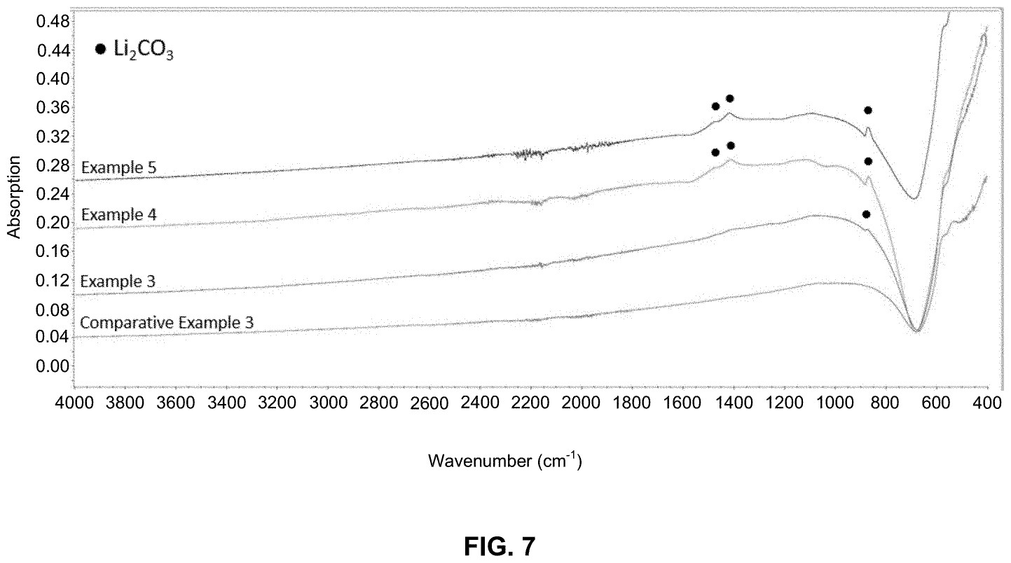

FIG. 7. is a plot of ATR-FTIR spectroscopy measurements of uncoated NMC-622 particles (Counter Example 3), NMC-622 particles exposed for 13 days to a 0.2% Relative Humidity (RH) at 21° C. (Example 3), NMC-622 particles exposed for 13 days at 20% RH at 21° C. (Example 4), and NMC-622 particles exposed for 13 days to a 73% RH at 21° C. (Example 5) to form Li₂CO₃ coating via atmospheric growth.

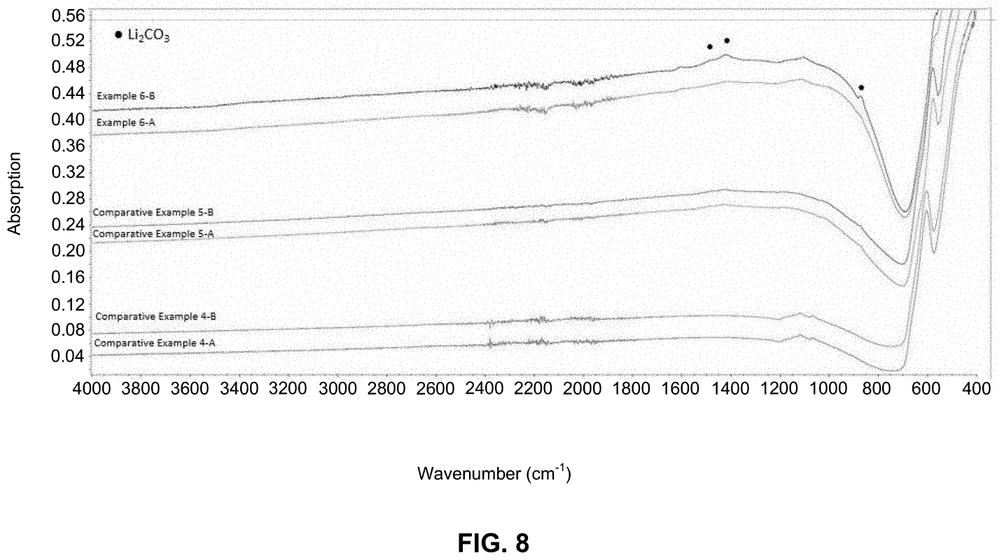

FIG. 8 is a plot of ATR-FTIR spectroscopy measurements of pristine uncoated NMC-622 particles (Example 6-A), NMC-622 particles exposed for 4 days to a 73.2% Relative Humidity (RH) at 21° C. (Example 6-B), pristine uncoated LMO particles (Comparative Example 4-A), LMO particles exposed for 4 days to a 73.2% Relative Humidity (RH) at 21° C. (Comparative Example 4-B), pristine uncoated LCO particles (Comparative Example 5-A), and LCO particles exposed for 4 days to a 73.2% Relative Humidity (RH) at 21° C. (Comparative Example 5-B).

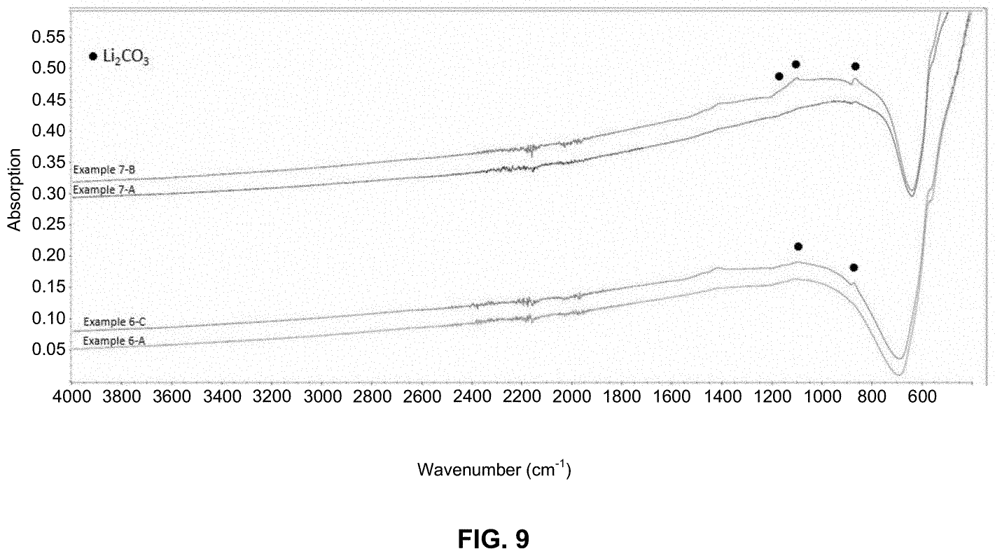

FIG. 9 is a plot of ATR-FTIR spectroscopy measurements of pristine uncoated NMC-622 particles (Example 6-A), NMC-622 particles exposed for 24 hours to a 73.2% Relative Humidity (RH) at 21° C. (Example 6-C), pristine uncoated NMC 851005 particles (Example 7-A), and NMC 851005 particles exposed for 24 hours to a 73.2% Relative Humidity (RH) at 21° C. (Example 7-B).

It should be understood that the cathode material produced via the embodiments of this discourse may have use in electrochemical cells such as those having one or more of a solid electrolyte, polymer electrolyte, liquid electrolyte, or solvent-in-salt electrolyte.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present disclosure, rather than as limiting the scope of the disclosure. In addition to the foregoing embodiments of disclosures, review of the detailed description and accompanying drawings will show that there are other embodiments of such disclosures. Accordingly, many combinations, permutations, variations and modifications of the foregoing embodiments of disclosures not set forth explicitly herein will nevertheless fall within the scope of such disclosures. The following claims are intended to cover generic and specific features described herein, as well as all statements of the scope of the present method and system, which, as a matter of language, might be said to fall there between.

### EXAMPLES

### Example 1

Formation of the Coating on the Cathode Active Material

20 g of dry uncoated NMC 622 (LiNi_{0.6}Mn_{0.2}Co_{0.2}O₂) particles were exposed to 25° C. atmospheric air for 20 days and the sample was agitated every 48 hours. Once a Li₂CO₃ layer of 20 nm had formed on the NMC 622 particles, the material was vacuum dried at 120° C. for 10 hours. The presence of Li₂CO₃ is shown in the ATR-FTIR spectroscopy measurement in FIG. 5.

Synthesis of the Solid-State Electrolyte Material

A sulfide solid electrolyte (Li₂S—P₂S₅-based glass ceramic containing LiCl) and Xylenes was placed in a 250 ml Zirconia milling jar with Zirconia media. The loaded mill jar was then placed in a Retsch PM 100 planetary mill and milled for 18 hours at 400 RPM. The material was collected and dried at 70° C. and then heated to 200° C. in inert (argon or nitrogen) environment.

Production of the Solid-State Lithium Metal Cell

First, the above-mentioned coated active material and the above-mentioned solid electrolyte material were mixed to generate a cathode mix. Next, a lithium solid state battery 200 as shown in the above-mentioned FIG. 2 was produced by using a pressing machine. The above-mentioned cathode mix was used as a cathode active material layer 220, a lithium metal anode in the form of a 600 microns thick chip was used as the negative electrode active material 250 and negative electrode 260, and the above-mentioned solid electrolyte was used as the separator 230, respectively. A lithium solid state battery was produced by using the layout described in FIG. 2.

### Example 2

Formation of the Coating on the Cathode Active Material

20 g of dry uncoated NCM 851005 (LiNi_{0.85}Mn_{0.05}Co_{0.1}O₂) particles were exposed to 20° C. atmospheric air for 9 days, and the sample was constantly agitated using a vibrating table. Once a Li₂CO₃ layer of 20 nm had formed on the NCM 851005 particles, the material was vacuum dried at 120° C. for 10 hours. The presence of Li₂CO₃ is shown in the ATR-FTIR spectroscopy measurement in FIG. 6.

Production of the Solid-State Lithium Metal Cell

The Solid-State lithium cell of Example 2 was prepared in the same manner as Example 1 except coated NCM 851005 (LiNi_{0.85}Mn_{0.05}Co_{0.1}O₂) particles were used as a cathode active material.

### Comparative Example 1

The Solid-State lithium cell of Comparative Example 1 was prepared in the same manner as Example 1 except uncoated NMC 622 (LiNi_{0.6}Mn_{0.2}Co_{0.2}O₂) particles were used as a cathode active material. The lack of Li₂CO₃ is shown in the ATR-FTIR spectroscopy measurement in FIG. 5.

### Comparative Example 2

The Solid-State lithium cell of Comparative Example 2 was prepared in the same manner as Example 2 except uncoated NCM 851005 (LiNi_{0.85}Mn_{0.05}Co_{0.1}O₂) particles were used as a cathode active material. The lack of Li₂CO₃ is shown in the ATR-FTIR spectroscopy measurement in FIG. 6.

Determining Necessary Humidity Range to Form Li₂CO₃ Coating

### Example 3

20 g of dry uncoated NMC 622 (LiNi_{0.6}Mn_{0.2}Co₀₂O₂) particles were exposed to 0.2% Relative Humidity (RH) for 13 days at a temperature of 21° and the sample was agitated every 48 hours. After the 13 days, the NMC 622 material was vacuum dried at 120° C. for 10 hours, and the presence of Li₂CO₃ is shown in the ATR-FTIR spectroscopy measurement in FIG. 7.

### Example 4

Example 4 was conducted in the same manner as Example 3 except the relative humidity was 20%. The presence of Li₂CO₃ is shown in the ATR-FTIR spectroscopy measurement in FIG. 7.

### Example 5

Example 5 was conducted in the same manner as Example 3 except the relative humidity was 73.2%. The presence of Li₂CO₃ is shown in the ATR-FTIR spectroscopy measurement in FIG. 7

### Comparative Example 3

20 g of dry uncoated NMC 622 (LiNi_{0.5}Mn_{0.2}Co_{0.2}O₂) particles were place in an inert gas environment with a relative humidity of 0% for 13 days at a temperature of 21° C. and the sample was agitated every 48 hours. After the 13 days, the NMC 622 material was vacuum dried at 120° C. for 10 hours, and an ATR-FTIR spectroscopy measurement was taken and shown in FIG. 7.

Evaluation of Solid-State Cells

Solid-state battery cells of Examples 1, 2, and Comparative Examples 1, 2 were respectively charged in constant current-constant voltage at a C-rate of 0.1 C ( 1/10 C) up to 4.3 V at the temperature of 70° C., and then discharged in constant current-constant voltage C-rate of 0.1 C ( 1/10 C) down to 2.5 V as a cycle. The discharge capacity at this time was measured. This cycle was repeated until a trend in discharge capacity fade could be established. As shown in FIG. 4A, the solid-state battery cell of Example 1 using a Li₂CO₃ coated NMC 622 has a higher starting discharge capacity than that of Comparative Example 1 using an uncoated NMC 622 material—123 mAh/g for Example 1 vs 116 mAh/g for Comparative Example 1. Additionally, the solid-state battery cell of Example 1 using a Li₂CO₃ coated NMC 622 shows a dramatically slower fade in discharge capacity as compared to Comparative Example 1. The solid-state battery cell of Example 1 cycles 85 times before its discharge capacity drops by 85% of starting capacity reaching 105 mAh/g at approximately the 85^{th} cycle. The solid-state battery cell of Comparative Example 1 cycles approximately 22 times before its discharge capacity drops by 85% of its starting capacity reaching 99 mAh/g at approximately the 22^{nd} cycle.

A similar result can be seen in FIG. 4B where the solid-state battery cell of Example 2 using a Li₂CO₃ coated NCM 851005 has a higher starting discharge capacity than that of Comparative Example 2 using an uncoated NMC 851005 material—137 mAh/g for Example 2 vs 120 mAh/g for Comparative Example 2. Additionally, the solid-state battery cell of Example 2 using a Li₂CO₃ coated NMC 851005 shows a dramatically slower fade in discharge capacity as compared to Comparative Example 2. The solid-state battery cell of Comparative Example 2 cycles only 3 times before its discharge capacity drops more than 85% of its starting capacity reaching approximately 97 mAh/g by the 3^{rd} cycle. The solid-state battery cell of Example 2 still maintains over 98% of its discharge capacity by the 3^{rd} cycle only dropping to approximately 137 mAh/g. From these examples described herein, it can be shown that by using lithium contained in a cathode active material to form a layer Li₂CO₃ on the surface of the cathode active material, initial discharge capacity and cycle life can be improved.

Evaluation of Necessary Humidity Levels

From examining the ATR-FTIR spectroscopy measurement in FIG. 7 of Counter Example 3, it can be shown that with a relative humidity level of 0% and a Carbon Dioxide free atmosphere, the NMC material was not able to form a Li₂CO₃ coating which was evident by the lack C—O stretching bands at v=1475 cm⁻¹ and 1417 cm⁻¹ and a carbonate bending mode at v=865 cm⁻¹. From the ATR-FTIR spectroscopy measurement in FIG. 7 of Example 3, the carbonate bending mode at v=865 cm⁻¹ can be seen while the C—O stretching bands at v=1475 cm⁻¹ and 1417 cm⁻¹ are hidden in the background. This is evidence of a very thin layer of Li₂CO₃ and an exposure of greater than 13 days at a relative humidity of 0.2% may be necessary to form a Li₂CO₃ of the desired thickness. The ATR-FTIR spectroscopy measurement in FIG. 7 of Examples 4 and 5 shows both the C—O stretching bands at v=1475 cm⁻¹ and 1417 cm⁻¹ and the carbonate bending mode at v=865 cm⁻¹.

Determining Cathode Components Necessary to Form Li₂CO₃ Coating

### Example 6-A

Pristine uncoated NMC 622 (LiNi_{0.6}Mn_{0.2}Co_{0.2}O₂) particles that were not exposed to humidity or CO₂ and an ATR-FTIR spectroscopy measurement was taken and shown in FIG. 8 and FIG. 9.

### Example 6-B

20 g of dry uncoated NMC 622 (LiNi_{0.6}Mn_{0.2}Co₀₂O₂) particles were exposed to 73.2% Relative Humidity (RH) for 4 days at a temperature of 21°. After the 4 days, the NMC 622 material was vacuum dried at 120° C. for 10 hours, and the presence of Li₂CO₃ is shown in the ATR-FTIR spectroscopy measurement in FIG. 8.

### Example 6-C

20 g of dry uncoated NMC 622 (LiNi_{0.6}Mn_{0.2}Co₀₂O₂) particles were exposed to 73.2% Relative Humidity (RH) for 24 hours at a temperature of 21°. After the 24 hours, the NMC 622 material was vacuum dried at 120° C. for 10 hours, and the presence of Li₂CO₃ is shown in the ATR-FTIR spectroscopy measurement in FIG. 9.

### Example 7-A

Pristine uncoated NCM 851005 (LiNi_{0.85}Mn_{0.05}Co_{0.1}O₂) particles that were not exposed to humidity or CO₂ and an ATR-FTIR spectroscopy measurement was taken and shown in FIG. 9.

### Example 7-B

Example 7-B was conducted in the same manner as Example 6-C except dry uncoated NCM 851005 (LiNi₀₈₅Mn_{0.05}Co_{0.1}O₂) particles were used, and the presence of Li₂CO₃ is shown in the ATR-FTIR spectroscopy measurement in FIG. 9.

### Comparative Example 4-A

Comparative Example 4-A was conducted in the same manner as Example 4-A except an LMO (Lithium-Manganese-Oxide) cathode material was used in place of the NMC material.

### Comparative Example 4-B

Comparative Example 4-B was conducted in the same manner as Example 6-B except an LMO (Lithium-Manganese-Oxide) cathode material was used in place of the NMC cathode material.

### Comparative Example 5-A

Comparative Example 5-A was conducted in the same manner as Example 6-A except an LCO (Lithium-Cobalt-Oxide) cathode material was used in place of the NMC material.

### Comparative Example 5-B

Comparative Example 5-B was conducted in the same manner as Example 6-B except an LCO (Lithium-Cobalt-Oxide) cathode material was used in place of the NMC material.

Evaluating Cathode Components Necessary to Form Li₂CO₃ Coating

From comparing the ATR-FTIR spectroscopy of Counter Example 4-A to Counter Example 4-B in FIG. 8, it can be shown that by exposing a cathode material containing Manganese (LMO) as it's only transition metal to 73.2% Relative Humidity (RH) for 4 days at a temperature of 21° C. no appreciable amount of Li₂CO₃ is formed. A similar result can be seen from comparing the ATR-FTIR spectroscopy of Counter Example 5-A to the ATR-FTIR spectroscopy of Counter Example 5-B in FIG. 8. In this comparison, a cathode material containing Cobalt (LCO) as its only transition metal was exposed to a Relative Humidity (RH) of 73.2% for 4 days at a temperature of 21° C. Again, no appreciable amount of Li₂CO₃ is formed. It is not until Nickel (e.g., a catalytic amount of Nickel) is incorporated into the cathode material that we see the formation of Li₂CO₃ which is shown by comparing the ATR-FTIR spectroscopy of Example 6-A to the ATR-FTIR spectroscopy of Example 6-B in FIG. 8. In this comparison, a cathode material containing Nickel as one of its transitional metals (NMC) was exposed to a Relative Humidity (RH) of 73.2% for 4 days at a temperature of 21° C. After this exposure, the ATR-FTIR spectroscopy of Example 6-B shows a C—O stretching bands at v=1475 cm⁻¹ and 1417 cm⁻¹ and a carbonate bending mode at v=865 cm⁻¹ which indicates the presence of Li₂CO₃ in FIG. 8. Furthermore, the ATR-FTIR spectroscopy of Example 6-C shows the same NMC material formed a layer of Li₂CO₃ after only 24 hours of being exposed to a Relative Humidity (RH) at 21° C.

FIG. 9 further showing the benefit of having Nickel (e.g., a catalytic amount of Nickel) as a component of the cathode materials. FIG. 9 shows that when two cathode materials containing different amounts of Nickel are exposed to the same temperature (21° C.), the same levels of RH (73.2%) and CO₂ (atmospheric) for the same amount of time (24 hours), that the cathode material containing higher amounts of Nickel will form a more substantial layer of Li₂CO₃ on the surface of the particles. The ATR-FTIR spectroscopy of Example 6-A and the ATR-FTIR spectroscopy of Example 6-C show an NMC 622 (LiNi_{0.6}Mn_{0.2}Co_{0.2}O₂) cathode material before and after the described exposure. the ATR-FTIR spectroscopy of Example 7-A and the ATR-FTIR spectroscopy of Example 7-B show an NCM 851005 (LiNi_{0.85}Mn_{0.05}Co_{0.1}O₂) cathode material before and after the described exposure. Comparing the ATR-FTIR spectroscopy of Example 6-C to the ATR-FTIR spectroscopy of Example 7-B in FIG. 9, the ATR-FTIR spectroscopy of Example 7-B has stronger C—O stretching band 1417 cm⁻¹ and a stronger carbonate bending mode at v=865 cm⁻¹ than the ATR-FTIR spectroscopy of Example 6-C, which shows a more abundant Li₂CO₃ layer on the NCM 851005 (LiNi_{0.85}Mn_{0.05}Co_{0.1}O₂). This comparison further demonstrates role of Nickel in the formation of a Li₂CO₃ on the surface of cathode materials such that by increasing the Nickel content within the cathode material, the rate at which Li₂CO₃ forms also increases.

From examples and Comparative Example, it can be shown that by exposing a lithium containing cathode active material to a relative humidity range of above 0% to 100% and atmospheric CO₂ for a time frame in accordance with the embodiments, a Li₂CO₃ layer can be formed.

What is claimed is:

1. A method for producing a lithium carbonate coated cathode for an electrochemical cell comprising the steps of:
exposing a nickel-based cathode material comprising a 1:2 molar ratio of lithium and oxygen to gaseous carbon dioxide and water vapor; and
incubating the nickel-based cathode material and the carbon dioxide for a predetermined amount time, at a predetermined temperature, at a predetermined pressure, and/or at a predetermined relative humidity level,
wherein lithium carbonate is formed as a layer on an exterior surface of the cathode material to form a lithium carbonate coated cathode.

2. The method of claim 1 wherein the nickel-based cathode material comprises the formula LiNiₐMn_{b}Co_{c}O₂ where 0<a<1, 0<b<1, 0<c<1 and a+b+c=1.

3. The method of claim 1 wherein the nickel-based cathode material comprises NMC 111 (LiNi_{0.33}Mn_{0.33} Co_{0.33} O₂), NMC 433 (LiNi_{0.4}Mn_{0.3}Co_{0.3} O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof.

4. The method of claim 1 wherein the nickel-based cathode material comprises one or more of a coated or uncoated metal oxide comprising LiNiO₂, LiNi_{1-Y}Co_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, Li(NiₐCo_{b}Al_{c})O₂ (0<a<1, 0<b<1, 0<c<1, a+b+c=1) or a combination thereof.

5. The method of claim 1 wherein the nickel-based cathode material further comprises one or more of a coated or uncoated metal oxide comprising V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (where 0≤Z≤2), LiCoPO₄, LiFePO₄, CuO, LiCo_{0.6}Mn_{0.4}O₂, LiMn_{1.5}Ni_{0.5}O₄, or a combination thereof.

6. The method of claim 1 wherein the nickel-based cathode material further comprises one or more of a coated or uncoated metal sulfide comprising titanium sulfide (TiS₂), molybdenum sulfide (MoS₂), iron sulfide (FeS or FeS₂), copper sulfide (CuS), nickel sulfide (Ni₃S₂) lithium sulfide (Li₂S), or combination thereof.

7. The method of claim 1 wherein the exposing includes applying an elevated pressure to increase the rate of growth of the lithium carbonate coating.

8. The method of claim 1 wherein the exposing includes applying an elevated temperature to increase the rate of growth of the lithium carbonate coating.

9. The method of claim 1 wherein the predetermined temperature ranges from about 20° C. to about 120° C.

10. The method of claim 1 wherein the exposing step includes applying an elevated concentration of gaseous carbon dioxide for a predetermined amount of time to increase the rate of growth of the lithium carbonate coating.

11. The method of claim 1 wherein the exposing step includes applying an elevated concentration of water vapor for a predetermined amount of time to increase the rate of growth of the lithium carbonate coating.

12. The method of claim 1 wherein the nickel-based cathode material is coated with a lithium-containing layer prior to exposing to gaseous carbon dioxide and water vapor.

13. The method of claim 12 wherein the lithium-containing layer comprises Li₂ZrO₃, Li₂ZrO₄, LiCl, LiF, LiOH, Li₂O, lithium niobate, lithium nitride, lithium titanate, lithium silicate or a combination thereof.

14. The method of claim 1 wherein the nickel-based cathode material is untreated prior to exposing to gaseous carbon dioxide and water vapor.

15. The method of claim 1 wherein the lithium carbonate coating has a thickness in the range from about 5 nanometers to about 1 micrometer.

16. The method of claim 1 further comprising vacuum drying of the lithium carbonate coated cathode to remove residual moisture.

17. The method of claim 1 further comprising washing of the lithium carbonate coated cathode.

18. The method of claim 1 further comprising combining the lithium carbonate coated cathode with one or more of suitable binders, solid electrolytes and conductive additives to form a cathode for an electrochemical cell.

19. The method of claim 1 further comprising integrating the lithium carbonate coated cathode with an anode and separator to form a functioning electrochemical cell.

20. An electrochemical cell comprising a lithium carbonate coated cathode having an exterior lithium carbonate coating with thickness in the range from about 2 nanometers to about 1 micron.

21. A method for gaseously producing a uniformly coated cathode with lithium carbonate, the method comprising the steps of:
contacting gaseous carbon dioxide and water vapor to a nickel-based cathode material comprising a lithium and oxygen; and
gaseously producing a uniformly coated cathode with lithium carbonate, wherein lithium carbonate is uniformly formed as a layer on an exterior surface of the cathode material to form a lithium carbonate coated cathode.
